(19) United States
(12) Patent Application Publication
(10) Pub. No.: US 2004/0234190 A1
(43) Pub. Date: Nov. 25, 2004

(54) Optical modules and method for manufacturing the same, and electronic devices

(76) Inventor: Osamu Omori, Nagano-Ken (JP)

Correspondence Address: HARNESS, DICKEY & PIERCE, P.L.C., P.O. BOX 828, BLOOMFIELD HILLS, MI, 48303, US

(21) Appl. No.: 10/803,481

(22) Filed: Mar. 18, 2004

(30) Foreign Application Priority Data
Mar. 20, 2003 (JP) 2003-078087

(51) Int. Cl. G02B 6/26

(52) U.S. Cl. 385/16

(57) ABSTRACT

An optical module is provided which includes a wiring substrate including a flexible substrate and a wiring pattern formed thereon, an optical chip including an electrode that is electrically connected to the wiring pattern and an optical section, and a base member that holds a lens that focuses light on the optical section. A surface of the optical chip having the electrode is opposite to the wiring substrate. The wiring substrate includes a light-transmissive section at a location that overlaps the optical section. The base member is affixed to the optical chip through the wiring substrate.

### RELATED APPLICATIONS

This application claims priority to Japanese Patent Application No. 2003-078087 filed Mar. 20, 2003 which is expressly incorporated by reference herein.

### BACKGROUND OF THE INVENTION

1. Technical Field of the Invention

The present invention relates to optical modules, methods for manufacturing the same, and electronic devices.

2. Conventional Technology

As a structure of optical modules for imaging systems such as CCDs and MOS sensors, a structure in which an optical chip is connected to a wiring substrate with wire bonding, and a housing is mounted in a manner to surround the optical chip is known. In this structure, since the housing is mounted using a surface of the wiring substrate as a reference, there is a possibility that it can be mounted in a tilted state with respect to the optical chip. For example, when the wiring substrate is warped due to heat generated during a mounting step, the optical axes of the optical section and the lens deviate from each other, such that the reliability of the optical module may be deteriorated.

It is an object of the present invention to accurately align the optical axes of the optical section and the lens.

### SUMMARY

An optical module in accordance with the present invention includes: a wiring substrate including a flexible substrate and a wiring pattern formed thereon; an optical chip including an electrode that is electrically connected to the wiring pattern, and an optical section; and a base member that holds a lens that focuses light on the optical section, wherein a surface of the optical chip having the electrode is opposite to the wiring substrate, the wiring substrate includes a light-transmissive section at a location that overlaps the optical section, and the base member is affixed to the optical chip through the wiring substrate.

According to the present invention, the base member is affixed to the optical chip through the wiring substrate. In other words, the base member can be mounted using the optical chip as a reference. Accordingly, a deviation between the optical axes of the optical section and the lens can be reduced, and therefore an optical module with a high image quality can be provided.

In the optical module, the base member may be affixed to the optical chip at a position of the electrode through the wiring substrate. Accordingly, for example, the optical axes of the optical section and the lens can be aligned within the range of variations in the flatness uniformity with respect to a plurality of electrodes, such that the two can be highly accurately aligned.

In the optical module, an electrical connection section between the electrode and the wiring pattern may be sealed with sealing material. Accordingly, the wiring substrate has a greater area that is supported by the optical chip, such that a base member can be more readily fixed.

In the optical module, the light-transmissive section may be an opening section of the flexible substrate.

In the optical module, the optical chip may include a plurality of the electrodes, the plurality of the electrodes may be electrically connected to the wiring pattern in a region around the opening section on the wiring substrate, and the base member may be provided to surround the opening section.

In the optical module, the base member may be adhered to the wiring substrate.

An electronic device in accordance with the present invention includes the optical module described above.

A method for manufacturing an optical module in accordance with the present invention includes the steps of: (a) placing an optical chip having an electrode and an optical section with a surface thereof having the electrode facing a wiring substrate including a flexible substrate and a wiring pattern formed thereon, overlapping the optical section with a light-transmissive section of the wiring substrate and electrically connecting the electrode and the wiring pattern; and affixing a base member that holds a lens for focusing light on the optical section to the optical chip through the wiring substrate.

According to the present invention, the base member is affixed to the optical chip through the wiring substrate. In other words, the base member can be mounted using the optical chip as a reference. Accordingly, a deviation between the optical axes of the optical section and the lens can be reduced, and therefore an optical module with a high image quality can be provided.

In the method for manufacturing an optical module, in the affixing step, the base member may be aligned by recognizing a mark. Accordingly, plane positions of the optical section and the lens can be accurately aligned.

In the method for manufacturing an optical module, the light-transmissive section may be an opening section of the flexible substrate, and the mark may be formed in a region of the optical chip which is exposed through the opening section.

In the method for manufacturing an optical module, the mark may be formed on the wiring substrate.

In the method for manufacturing an optical module, the mark may be a pattern formed in the same step in which the wiring pattern is formed.

### BRIEF DESCRIPTION OF THE DRAWINGS

FIG. 1 is a view showing an optical module in accordance with an embodiment of the present invention.

FIG. 2 is a view showing an optical chip of an optical module in accordance with an embodiment of the present invention.

FIG. 3 is a view showing a method for manufacturing an optical module in accordance with an embodiment of the present invention.

FIG. 4 is a view showing the method for manufacturing an optical module in accordance with the embodiment of the present invention.

FIG. 5 is a view showing the method for manufacturing an optical module in accordance with the embodiment of the present invention.

FIG. 6 is a view showing the method for manufacturing an optical module in accordance with the embodiment of the present invention.

FIG. 7 is a view showing an electronic device in accordance with an embodiment of the present invention.

FIG. 8 is a view showing an electronic device in accordance with an embodiment of the present invention.

FIG. 9 (A) and FIG. 9 (B) are views showing an electronic device in accordance with an embodiment of the present invention.

### DETAILED DESCRIPTION

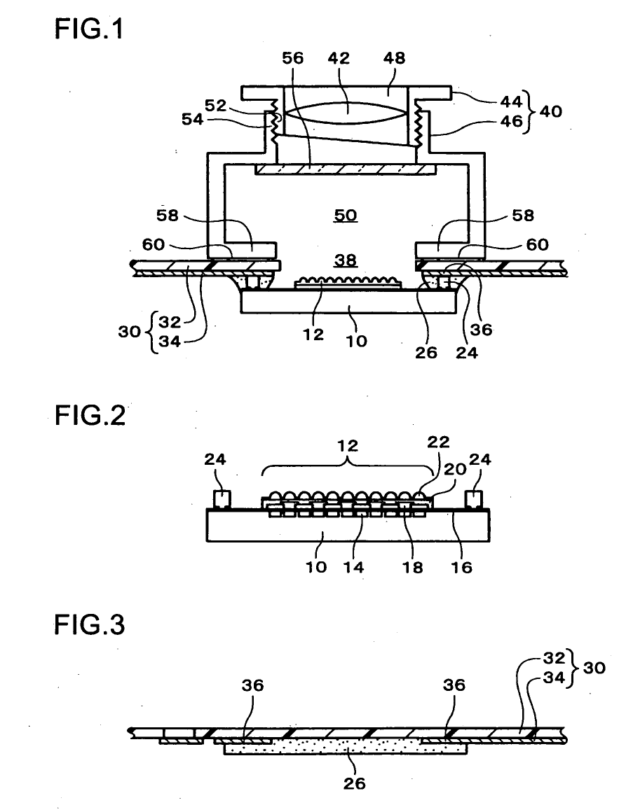

An embodiment of the present invention will be described below with reference to the accompanying drawings. FIGS. 1-6 are views for describing an optical module in accordance with an embodiment of the present invention and a method for manufacturing the same. More specifically, FIG. 1 is a cross-sectional view of an optical module and FIG. 2 is a cross-sectional view of an optical chip. FIGS. 3-6 are views showing a method for manufacturing an optical module. An optical module in accordance with an embodiment of the present invention includes an optical chip 10, a wiring substrate 30 and a base member 40.

The optical chip 10 may often be in a rectangular parallelepiped shape. The optical chip 10 may be a semiconductor chip. As indicated in FIG. 2, the optical chip 10 includes an optical section 12. The optical section 12 is a portion where light enters or exits. Also, the optical section 12 converts optical energy to another type of energy (for example, electricity). More specifically, the optical section 12 includes a plurality of energy converting elements (light sensing elements, light emission elements) 14. In the present embodiment, the optical section 12 is a light sensing section. In this case, the optical chip 10 is a light sensing chip (for example, an imaging chip). The plurality of energy converting elements (light sensing elements or image sensor elements) 14 are two-dimensionally arranged to perform image sensing. In other words, in accordance with the present embodiment, the optical module is an image sensor (CCD or CMOS sensor). The energy converting elements 14 are covered by a passivation film 16. The passivation film 16 is light-transmissive. When the optical chip 10 is fabricated from a semiconductor substrate (for example, a semiconductor wafer), the passivation film 16 may be formed from a silicon oxide film or a silicon nitride film.

The optical section 12 may include color filters 18. The color filters 18 are formed on the passivation film 16. Also, a planarizing layer 20 may be provided over the color filters 18, and a micro lens array 22 may be provided thereon.

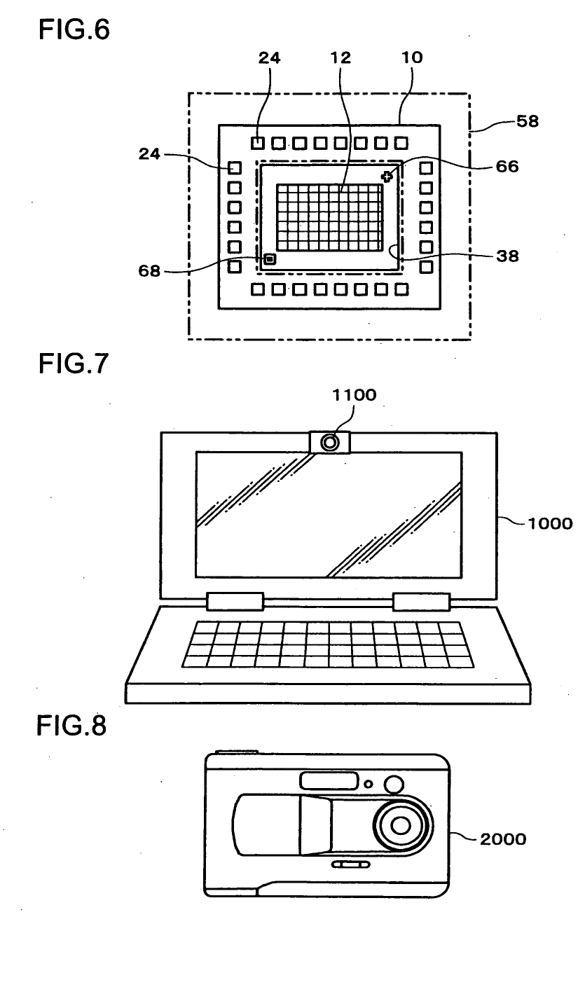

The optical chip 10 includes an electrode 24 (a plurality of electrodes 24 in many occasions). The electrode 24 is electrically connected to the optical section 12. The electrode 24 includes a bump formed on a pad, but may be formed only from a pad. The bump may be formed from metal (for example, gold), and may preferably have a flat top surface. More specifically, the upper end surface of the bump may preferably be flat after a bonding step for the optical chip 10. The electrodes 24 are formed outside the optical section 12. The optical section 12 and the electrodes 24 may be formed on the same surface of the optical chip 10. When the optical chip 10 is square (for example, in a quadrilateral shape), the electrodes 24 may be disposed along a plurality of sides (for example, opposing two sides or four sides) or along one side (see FIG. 6).

The wiring substrate 30 includes a flexible substrate 32 and a wiring pattern 34 formed on the flexible substrate 32. The flexible substrate 32 is formed from a material having a higher flexibility that that of the optical chip 10. The flexible substrate 32 may be a film that is used in the case of COF (Chip On Film) mounting or TAB (Tape Automated Bonding) mounting. The flexible substrate 32 has flexibility to the extent that its shape can be defined according to the shape of the optical chip 10 after mounting. The flexible substrate 32 may be formed from organic material, for example, may be a polyimide substrate or a polyester substrate. It is noted that the wiring substrate 30 also has a flexibility like the flexible substrate 32.

The wiring pattern 34 may be formed on one surface of the flexible substrate 32 or on both surfaces thereof, by using a known technique such as a plating technique, an exposure technique, or the like. The wiring pattern 34 is composed of a plurality of wirings, and a plurality of terminals that define electrical connection sections. The terminals may be in the form of lands. Each of the terminals is electrically connected to a specified electronic component. In the example shown in FIG. 1, the terminals 36 of the wiring pattern 34 are electrically connected to the optical chip 10. The plurality of terminals 36 may be disposed around an opening section 38 of the flexible substrate 32 as described below.

The wiring substrate 30 includes a light-transmissive section. The light-transmissive section is a portion that defines a light path for the optical section 12. In the example shown in FIG. 1, the light-transmissive section is an opening section 38 formed in the flexible substrate 32. The opening section 38 is a penetrated hole formed in the flexible substrate 32, which is formed to be larger than the outer shape of the optical section 12 (see FIG. 6). As a modified example, the light-transmissive section may further include a light-transmissive substrate not shown (for example, a transparent substrate such as a glass substrate) that is mounted on the flexible substrate 32 in a manner to cover the opening section 38. Alternatively, all or a part of the wiring substrate 30 may be formed from a light-transmissive section. In other words, at least a part of the flexible substrate 32 in an area corresponding to the optical section 12 may be light transmissive.

As indicated in FIG. 1, the optical chip 10 is mounted on the wiring substrate 30. More specifically, the optical chip 10 is electrically connected to the wiring pattern 34 (more specifically, to the terminals 36) through the electrodes 24. A surface of the optical chip 10 having the electrodes 24 is opposite to the wiring substrate 30. In other words, the optical chip 10 is face-down mounted on the wiring substrate 30. For electrical connection between the electrodes 24 and the terminals 36, anisotropic conductive material 26 such as an anisotropic conductive film (ACF), anisotropic conductive paste (ACP) or the like may be used to provide conductive particles between the electrodes 24 and the terminals 36. The anisotropic conductive material 26 serves as sealing material at bonding sections between the electrodes 24 and the terminals 36. The anisotropic conductive material 26 is provided in a manner not to cover the optical section 12. Alternatively, the electrical connection between the two may be achieved by metal bonding with Au—Au, Au—Su or solder. Also, non-conductive paste (NCP) or a non-conductive film (NCF) that does not include conductive particles may be used. The electrical connection section between the electrodes 24 and the terminals 36 may preferably be sealed with sealing material (for example, resin). Bumps that are used as the electrodes 24 may be preferable as electrical connection thereto can be made easily. Alternatively, bumps may be formed on the wiring pattern 34 (more specifically, on the terminals 36).

As indicated in FIG. 1, the optical section 12 of the optical chip 10 overlaps the light-transmissive section (the opening section in FIG. 1). In other words, the optical section 12 is disposed inside the opening section 38. As a result, a light path can be secured for the optical section 12. Further, the plurality of electrodes 24 are electrically connected to the wiring pattern 34 (more specifically, to the terminals 36) in a region around the opening section 38. For example, the outer shape of the optical chip 10 may be formed to be larger than the outer shape of the opening section 38, and the opening section 38 may be covered by the optical chip 10 (see FIG. 6)

Aside from the example shown in FIG. 1, the optical module may further include electronic components other than the optical chip 10. The electronic components are electrically connected to the terminals of the wiring pattern 34. The electronic components are parts that are used for processing electrical signals, which may be active components (integrated circuit chips or the like) and/or passive components (resistors, capacitors).

The optical module includes a base member 40. The base member 40 holds a lens 42 that focuses light on the optical section 12. The base member 40 is an outer casing (case) of the optical chip 10, and may also be referred to as a housing. The lens 42 is provided at a position corresponding to the optical section 12 (a position that overlaps the optical section 12 in FIG. 1). The lens 42 may be detachably mounted on the base member 40. When the base member 40 and the lens 42 are used for imaging, these components may be called an imaging optical system. The base member 40 may be composed of members that can be mutually separated, or integrally formed with one member.

In the example shown in FIG. 1, the base member 40 includes first and second base members 44 and 46. The lens 42 is attached to the first base member 44. In other words, the first base member 44 is a lens folder. More specifically, the first base member 44 includes a first hole 48, and retains the lens 42 within the first hole 48. The lens 42 may be fixed inside the first hole 48 by a pressing structure (not shown) including a pressing tool that is formed with screw threads (not shown) formed on the inside of the first base member 44 so that the lens 42 can be moved in the axial direction of the first hole 48. The lens 42 is held and spaced a distance from the optical section 12 of the optical chip 10.

As indicated in FIG. 1, the second base member 46 includes a second hole 50, and the first base member 44 is retained in the second hole 50. The first and second holes 48 and 50 are connected to each other to form one penetrating hole. On the outside of the first base member 44 and on the inside of the second hole 50 of the second base member 46 are formed first and second screws 52 and 54, whereby the first and second base members 44 and 46 are connected to each other. By the first and second screws 52 and 54, the position of the first base member 44 can be adjusted along the axial direction of the second hole 50 of the second base member 46. In this manner, the focal point of the lens 42 can be adjusted. It is noted that, above the optical section 12, an optical filter 56 may be provided. The optical filter is provided between the optical section 12 and the lens 42. As indicated in FIG. 1, the optical filter 56 may be provided within the second hole 50. The optical filter 56 may be one that changes optical loss according to wavelengths, or that only transmits light with specified wavelengths.

The base member 40 is affixed to the optical chip 10 through the wiring substrate 30. More specifically, the base member 40 is attached to an area among the wiring substrate 30 that is supported by the optical chip 10. Since the wiring substrate 30 is more flexible than the optical chip 10, and follows the shape optical chip 10, the flatness of the base member 40 is determined by the optical chip 10. In other words, the base member 40 can be mounted using the optical chip 10 as a reference, such that the optical axes of the optical section 12 and the lens 42 can be accurately aligned.

As indicated in FIG. 1, the base member 40 may be affixed to the optical chip 10 at positions of the electrodes 24 through the wiring substrate 30. Accordingly, the flatness of the base member 40 is determined according to the uniformity in the flatness of the contact surfaces (for example, upper end faces of the bumps) of the plurality of electrodes 24 with respect to the wiring pattern 34. Therefore, the optical axes of the optical section 12 and the lens 42 can be aligned within the range of variations in the uniformity in the flatness with respect to the plurality of electrodes 24, such that the two members can be highly accurately aligned. When the plurality of electrodes 24 are disposed in a region around the opening section 38, the base member 40 is disposed in a manner to surround the opening section 38. When the plurality of electrodes 24 are arranged along the four sides of the optical chip 10 that is a quadrilateral, the base member 40 may preferably be affixed at positions of the plurality of electrodes 24 that are arranged along at least two opposing sides (more preferably, along the four sides). By doing this, the base member 40 can be affixed at multiple locations, such that the base member 40 can be affixed in a flat state. Also, the bonding sections between the electrodes 24 and the wiring pattern 34 (more specifically, the terminals 36) may be sealed with sealing material (the anisotropic conductive material 26 in FIG. 1), such that the wiring substrate 30 has a greater area that is supported by the optical chip 10, and the base member 40 can be more readily affixed.

In the example shown in FIG. 1, the second base member 46 includes a mounting section 58 that is defined by an open end section of the second hole 50, and surfaces of the mounting section 58 are in contact with the wiring substrate 30. The contact surfaces between the mounting section 58 and the wiring substrate 30 may be formed in the shape of a frame that surrounds the circumference of the opening section 38 (see FIG. 6). The mounting section 58 may be adhered to the wiring substrate 30. In this case, adhesive material 60 may preferably be in a solid shape (for example, a sheet shape) that has a predetermined configuration. As a result, the flatness of the base member 40 can be maintained. In the example shown in FIG. 1, the adhesive material 60 is formed from a double-stick (double-sided) tape.

In the optical module in accordance with the present embodiment, the base member 40 is affixed to the optical chip 10 through the wiring substrate 30. In other words, the base member 40 can be mounted using the optical chip 10 as a reference. By this, the deviation of the optical axes of the optical section 12 and the lens 42 can be reduced, and the optical module with a high image quality can be provided. Also, the base member 40 can be formed to have generally the same size as the size of the optical chip, and the optical module can be reduced in size.

A method for manufacturing an optical module in accordance with the present invention includes the steps of electrically connecting electrodes 24 of an optical chip 10 to a wiring pattern 34, and affixing a base member 40 to the optical chip 10 through a wiring substrate 30.

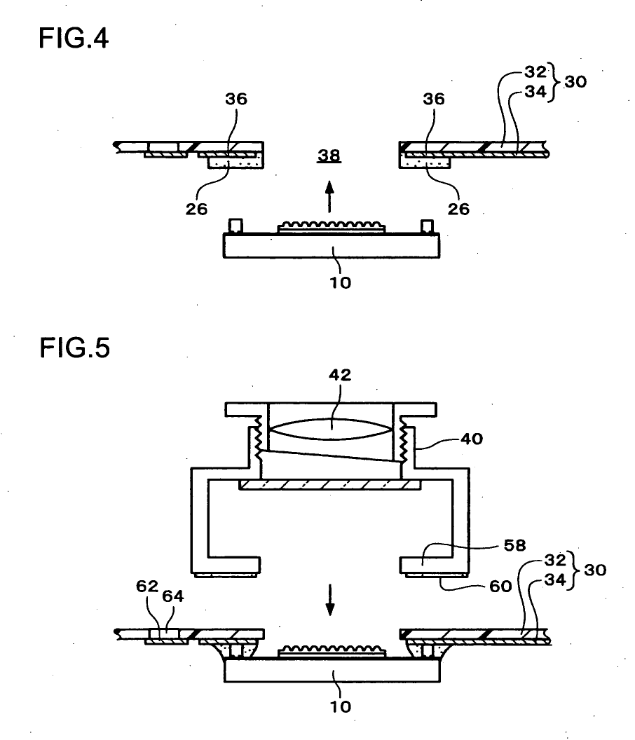

As indicated in FIG. 3, a wiring substrate 30 is prepared. Anisotropic conductive material 26 is provided in a region of the wiring substrate 30 where an optical chip 10 is mounted. The anisotropic conductive material 26 is provided in a manner to cover at least terminals 36 of a wiring pattern 34. Next, as indicated in FIG. 4, an opening section 38 is formed in a flexible substrate 32. The opening section 38 may be formed by punching through a portion of the flexible substrate 32. As indicated in FIG. 3 and FIG. 4, the anisotropic conductive material 26 in a sheet shape may be provided on the wiring substrate 30, and the flexible substrate 32 and the anisotropic conductive material 26 may be punched through simultaneously.

As indicated in FIG. 4, the optical chip 10 is mounted. More specifically, an optical section 12 thereof is overlapped with a light-transmissive section (an opening section 38 in FIG. 4) of the wiring substrate 30, and the optical chip 10 is face-down mounted on the wiring substrate 30. The contents described above can be applied to the mounting step and other details concerning the optical chip 10.

As indicated in FIG. 5, the base member 40 is affixed to the optical chip 10 through the wiring substrate 30. More specifically, a mounting section 58 of the base member 40 is adhered to the wiring substrate 30 with adhesive material 60. The base member 40 may be aligned by recognizing a mark 62. More specifically, by recognizing marks 62 at a plurality of locations, the plane position (positions in longitudinal and transverse directions and rotational (X, Y, θ) directions) of the base member 40 can be specified.

In the example indicated in FIG. 5, the marks 62 are formed on the wiring substrate 30. The marks 62 may be formed on the wiring substrate 30 in a region outside the base member 40. The marks 62 may be patterns that are formed in the same step of forming the wiring pattern 34, and may be formed with the same material as that of the wiring pattern 34. In the example shown in FIG. 5, the wiring pattern 34 is formed on one surface of the flexible substrate 32, and the marks 62 can be recognized through penetrated holes 64 in the flexible substrate 32. By recognizing the marks 62, the plane positions of the optical section 12 and the lens 42 can be accurately aligned with each other.

As a modified example, as shown in FIG. 6, marks for position alignment may be formed on the optical chip 10. In the example shown in FIG. 6, first and second marks 66 and 68 are formed on the optical chip 10 in a region where they are exposed through the opening section 38. The first and second marks 66 and 68 are formed outside the optical section 12. In the present step, the first and second marks 66 and 68 are recognized within the opening section 38. It is noted that other features and effects provided by the method for manufacturing an optical module in accordance with the present embodiment can be derived from the contents described above in conjunction with the optical module.

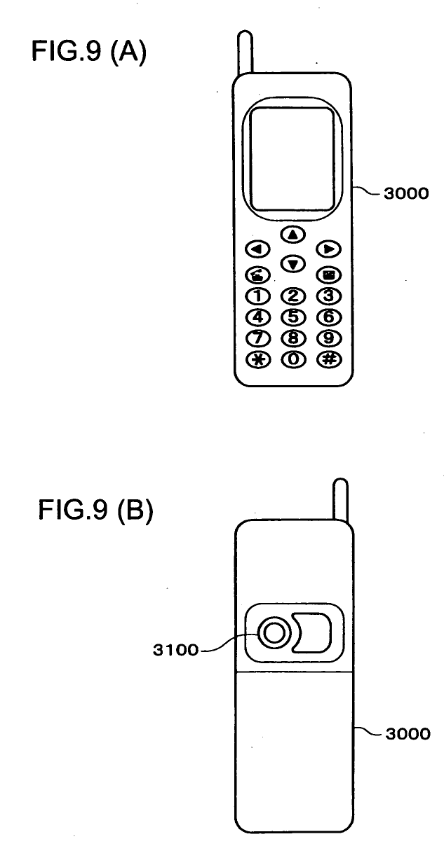

As electronic devices in accordance with embodiments of the present invention, a notebook type personal computer 1000 shown in FIG. 7 includes a camera 1100 having an optical module mounted thereon. Also, a digital camera 2000 shown in FIG. 8 includes an optical module. Further, a portable telephone 3000 shown in FIG. 9 (A) and FIG. 9 (B) includes a camera 3100 having an optical module mounted thereon.

The present invention is not limited to the embodiments described above, and many modifications can be made. For example, the present invention may include compositions that are substantially the same as the compositions described in the embodiments (for example, a composition with the same function, method and result, or a composition with the same objects and result). Also, the present invention includes compositions in which portions not essential in the compositions described in the embodiments are replaced with others. Also, the present invention includes compositions that achieve the same functions and effects or achieve the same objects of those of the compositions described in the embodiments. Furthermore, the present invention includes compositions that include publicly known technology added to the compositions described in the embodiments.

What is claimed is:

1. An optical module comprising:
a wiring substrate including a flexible substrate and a wiring pattern formed thereon;
an optical chip including an electrode that is electrically connected to the wiring pattern, and an optical section; and
a base member that holds a lens that focuses light on the optical section,
wherein a surface of the optical chip having the electrode is opposite to the wiring substrate,
the wiring substrate includes a light-transmissive section at a location that overlaps the optical section, and
the base member is affixed to the optical chip through the wiring substrate.

2. An optical module according to claim 1, wherein the base member is affixed to the optical chip at a position of the electrode through the wiring substrate.

3. An optical module according to claim 2, wherein an electrical connection section between the electrode and the wiring pattern is sealed with sealing material.

4. An optical module according to claim 1, wherein the light-transmissive section comprises an opening section of the flexible substrate.

5. An optical module according to claim 4, wherein the optical chip includes a plurality of the electrodes, the plurality of the electrodes are electrically connected to the wiring pattern in a region around the opening section on the wiring substrate, and the base member is provided to surround the opening section.

6. An optical module according to claim 1, wherein the base member is adhered to the wiring substrate.

7. An electronic device including the optical module according to claim 1.

8. A method for manufacturing an optical module, comprising:
step (a) including:
placing an optical chip on a wiring substrate, the optical chip having an electrode and an optical section, a surface of the optical chip including the electrode facing the wiring substrate, the wiring substrate including a flexible substrate and a wiring pattern formed on the flexible substrate;
overlapping the optical section with a light-transmissive section of the wiring substrate; and
electrically connecting the electrode and the wiring pattern; and
step (b) including:
affixing a base member to the optical chip through the wiring substrate, the base member holding a lens for focusing light on the optical section.

9. A method for manufacturing an optical module according to claim 8, wherein, in step (b), the base member is aligned by recognizing a mark.

10. A method for manufacturing an optical module according to claim 9, wherein the light-transmissive section comprises an opening section of the flexible substrate, and the mark is formed in a region of the optical chip which is exposed through the opening section.

11. A method for manufacturing an optical module according to claim 9, wherein the mark is formed on the wiring substrate.

12. A method for manufacturing an optical module according to claim 9, wherein the mark is a pattern formed in the same step in which the wiring pattern is formed.
